(19) United States
(12) Patent Application Publication
(10) Pub. No.: US 2014/0042727 A1
(43) Pub. Date: Feb. 13, 2014

(54) RECONFIGURABLE WHEEL CHAIRS

(71) Applicant: Chaitanya Kumar Musham, Little Rock, AR (US)

(72) Inventor: Chaitanya Kumar Musham, Little Rock, AR (US)

(21) Appl. No.: 13/572,922

(22) Filed: Aug. 13, 2012

(51) Int. Cl. A61G 5/10

(52) U.S. Cl. 280/304.1

(57) ABSTRACT

The present invention relates to a reconfigurable wheel chair designed to assist physically challenged people to use toilets without moving off wheel chairs. The wheel chair comprises a split seat, which includes a central retractable part. The rest of said seat is a sliding part, which rests on rails and is free to move over the toilet seat when enabled using mechanisms known in the art such as motor screw mechanism, etc. The wheel chair further comprises a sensor for aligning the chair to the toilet seat automatically. In use, once the wheel chair is aligned, the retractable part of the seat moves down. The roller at the back of the wheelchair seat is moved down onto the toilet to provide additional support. The motor is then activated that moves the sliding part of the seat over the toilet seat.

### BACKGROUND OF THE INVENTION

1. Field of the Invention

The present invention relates to wheel chairs, and more specifically to a reconfigurable wheel chair designed to assist physically challenged people to use toilets without moving off wheel chairs. The reconfigurable wheel chair of the present invention comprises a split seat including a central retractable part that can be moved down to the base of a wheel chair, and a surrounding sliding part that can be moved over a toilet seat.

2. Description of Related Art

The prior art provides a number of designs of wheel chairs capable of being wheeled over a toilet, while the occupant remains in the wheel chair. More specifically, by way of example, U.S. Pat. No. 2,086,550 to Hartig discloses a wheel chair having a main seat member which is stationary and is provided with a central opening and having an auxiliary seat member pivotally mounted on the underside to close said opening. U.S. Pat. No. 3,061,368 to Matthews discloses wheel chairs having toilet seat incorporated therein, the toilet seat having an opening adapted to be closed by a padded panel, which may be moved between a position closing said opening and a position clearing said opening by a person seated in the wheel chair. U.S. Pat. No. 3,062,582 to Baldwin discloses wheel chairs wherein a selected portion of the seats of the wheel chairs is permitted to be displaced for affording access to a toilet bowl received there beneath. U.S. Pat. No. 3,719,390 to Haney discloses a wheel chair with an auxiliary frame, which includes a pair of vertically oriented legs and a lifting-bar suspended between the legs so that the user can draw himself to an erect position in order to gain access to the toilet bowl. U.S. Pat. No. 4,343,482 to Wegner discloses collapsible wheel chairs that are capable of being wheeled over a toilet and permit users to use toilet without having to be moved from wheel chairs. U.S. Pat. No. 4,514,867 to Jensen discloses a wheel chair with displaceable seat panel which includes a pivoted central panel that can be pivoted downward so that the wheel chair can be wheeled over a toilet for use without transfer of the user from the wheel chair. U.S. Pat. No. 6,209,901 to Patel discloses wheel chair with a waste elimination opening provided in the seat and a cover for covering said opening when it is not needed. U.S. Pat. No. 6,839,918 to Jensen discloses a collapsible wheel chair with displaceable seat panels. The seat frame includes at least one seat section, which may each be independently raised or lower on one end thereof.

Some of the aforementioned inventions suffer from the inconvenience that the cover for the opening or the movable seat panel may be placed in the way of users' legs. Some of them may not suitable for users who are not competent to manually open and close the opening for waste elimination. For example, an elderly person or a user suffering partial paralysis may be unable to bend or twist to an extent necessary to manipulate structure supported beneath their seats.

Accordingly, there is a clearly felt need in the art for a wheel chair, which may be easily moved over a toilet seat by a physically weak user. Moreover, opening on the wheel chair seat to eliminate waste over the toilet can be easily operated by mechanical force. The movable seat panel or cover of the opening should stay out of the user's legs for comfort.

### SUMMARY OF THE INVENTION

The primary object of the present invention is to provide a reconfigurable wheel chair that enables the user to use toilet without moving off the wheel chair so that any loss of balance and accidents can be avoided and prevented.

Another objective of the present invention is to provide a reconfigurable wheel chair that enables users who are not competent to manually open and close the opening for waste elimination and, for elders or partially paralyzed users who cannot bend or twist to manipulate the structure of the wheel chair.

Yet another objective of the present invention is to provide a reconfigurable wheel chair of which the movable seat panel or cover of the opening should stay out of the user's legs for comfort.

Still another objective of the present invention is to provide a reconfigurable wheel chair which can be used in any toilets including home or outside. The dimensions are adjusted according to the ANSI A117.7 standard set by the Americans with Disabilities Act (ADA).

In an exemplary embodiment of the present invention, there is disclosed a reconfigurable wheel chair, which has several variations compared to the typical wheel chair. The wheel chair of the present invention has a split seat which includes a retractable part and a sliding part. The retractable part is oval in shape located at the center of the split seat. The rest of the seat surrounding the retractable part is the sliding part. The sliding part rests on rails and is free to move over the toilet seat when enabled.

The sliding-part seat can be moved forward and back using many mechanisms like the linear actuators, motor screw mechanism etc. The selection is made based on the cost of built and other factors. The motor screw mechanism is built in the preferred embodiment.

The motor screw mechanism consists of a motor and a long screw attached to it. The motor screw mechanism is useful to convert the rotational motion of the motor-screw into linear motion. There is a pillow block mounted on this motor screw mechanism as housing. The seat is attached to the pillow block. The seat can be moved forward or backward depending on the direction of rotation of the motor. Two rails are used to support the seat. For users' comfort, the motor-screw mechanism is assembled such that there is no obstruction to the user's legs when the seat moves onto the toilet seat. Linear actuator is built in another embodiment. Linear actuators are straight forward and known to people of ordinary skills in the art.

In one embodiment, the retractable part has a joint mechanism that can retract the seat to the base of the chair, not obstructing the legs of the user.

The wheel chair may further include a roller. Once the retractable-part is moved down, the roller at the back of the wheel chair can move down to provide additional support as the seat starts moving back.

The wheel chair may further comprise sensors. Once the user enters the restroom, sensors could be used to align the chair to the toilet seat automatically. The sensors are mounted onto the wheel chair. Two of the many possible mechanisms are described below.
Tracking With Beacon—This mechanism includes a sensor mounted at the back of the chair (S1) and another at the front of the toilet (S2). The S1 emits infrared (IR) radiation that detects the location of the S2. Once detected, the wheel chair is automatically routed to align with the toilet.
Tracking With Line—This involves drawing a line on the floor from the restroom door to the toilet. Sensors are mounted at the base of the chair to detect the line. This sensor, once enabled, can track the line to the seat automatically.

Once the wheel chair is aligned, the retractable part of the seat moves down. The roller at the back of the seat can be used for additional support. This roller moves down onto the toilet seat. The motor is activated now, that moves the sliding part of the seat into position, on the toilet seat.

The reconfigurable wheel chair of the present invention is designed to be used in any toilets including home or outside. The dimensions are adjusted according to the ANSI A117.7 standard set by the Americans with Disabilities Act (ADA).

The reconfigurable wheel chair according to the present invention may further comprise microchips that can control the joint mechanism to withdraw the retractable-part seat, the motor screw mechanism to move sliding-part seat forward or backward, the roller to move down onto the toilet seat, and the sensors for tracking and alignment between wheel chair and toilet seat. The wheel chair of the present invention may be controlled by wire or wireless remote control. The aforementioned mechanisms may be manually operable, for example, the joint mechanism and roller may be controlled by handles or a levers; the motor screw mechanism may be controlled by a rotating knob or a button.

The more important features of the invention have thus been outlined in order. More detailed description is provided in order so that the present contribution to the art may be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front perspective view of an embodiment of a reconfigurable wheel chair according to the present invention.

FIG. 2 is a bottom view of the seat portion showing the motor screw mechanism and a pair of seat rails under the sliding part of the wheel chair seat according to the present invention.

FIG. 3 is a zoom in view of the joint mechanism supporting the central retractable part of the wheel chair seat according to the present invention.

FIG. 4 is a rear perspective view showing the retractable part of the wheel chair seat moved down to the space in between two wheels after being withdrawn by the joint mechanism.

FIG. 5 is a rear perspective view showing the sliding-part seat is over the toilet seat and is supported by the roller at the back of the back member.

### DESCRIPTION OF THE PREFERRED EMBODIMENT

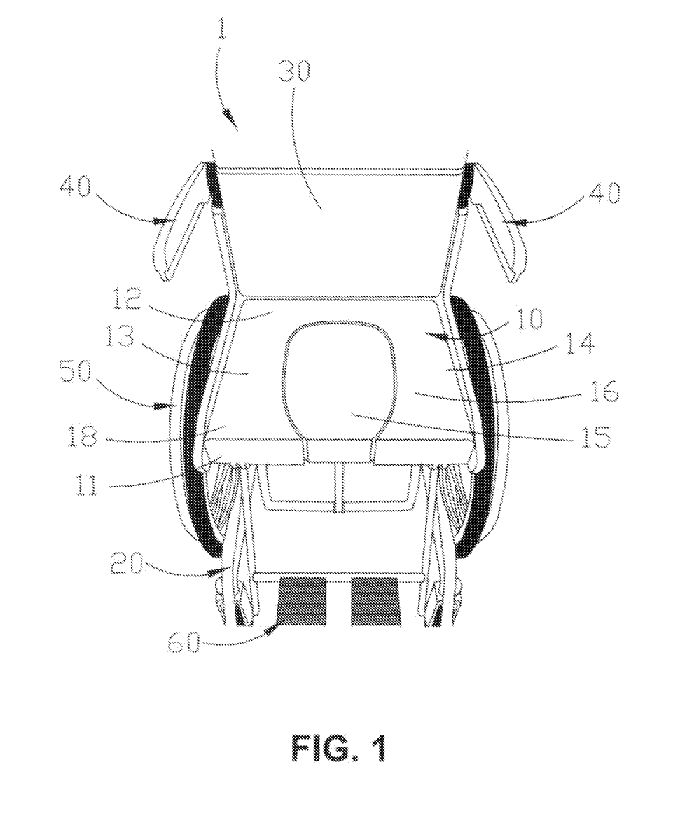

Referring to FIG. 1, there is disclosed a front perspective view of the preferred embodiment of the reconfigurable wheel chair 1 according to the present invention. The reconfigurable wheel chair 1 according to the present invention comprises a split seat 10, a base member 20, a back support member 30, two hand supports 40, at least a pair of chair wheels 50, and a pair of foot pedals 60. The reconfigurable wheel chair 1 may further comprise sensors 70.

The split seat 10 has a front end 11, a rear end 12, a right side 13, a left side 14, a top 18, and a bottom 19. The right side 13 and left side 14 extend between the front end 11 and rear end 12. The back support member 30 is connected to the rear end 12 of the split seat 10 in a generally perpendicular relation. The hand supports 40 are placed at the left and right side of the back member 30. The chair base member 20 is made up of metallic frame and is installed below the split seat 10 for providing support to wheel chair seat 10, back member 30, and weight of users.

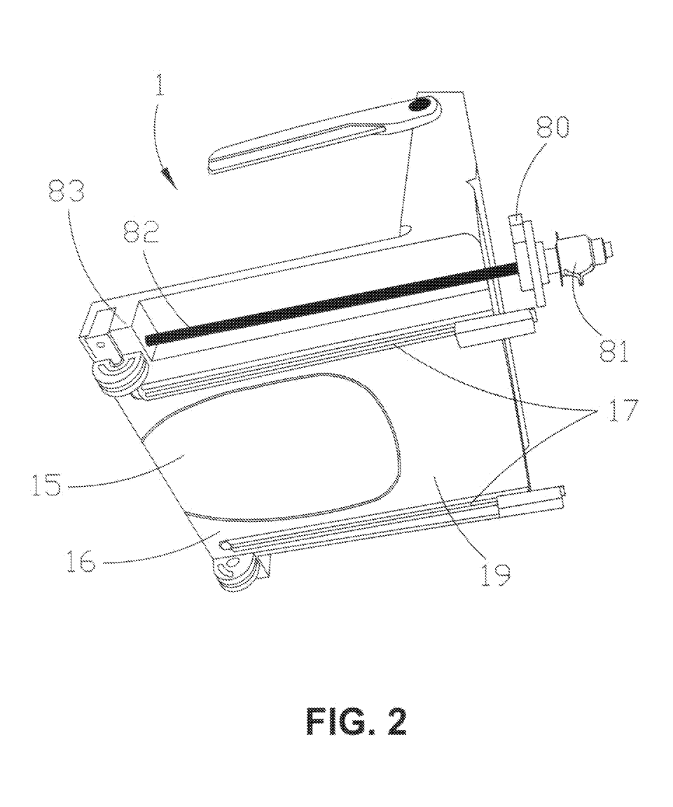

The split seat 10 is rigid and can be upholstered and cushioned for comfort. The split seat 10 includes a retractable-part seat 15 which is oval in shape extending backwards from the central front end 11. The remaining portion of the split seat 10 surrounding the retractable-part seat 15 is called sliding-part seat 16. The sliding-part seat 16 is connected to the back member 30 while the retractable-part seat 15 is not. As disclosed in FIG. 2 which shows a bottom view of a seat portion 10, the wheel chair further includes a pair of heavy duty seat rails 17 that are affixed to the bottom of the right side 13 and left side 14 of the split seat 10 and extend between the front 11 and rear ends 12 of the split seat 10. The seat rails 17 are further connected with the base member 20 (not shown in FIG. 2) so that the rails 17 can support the user's weight while the sliding-part seat 16 is moved forward and backward on the rails 17 over the toilet seat 2.

The sliding-part seat 16 can be moved forward and backward on the rails 17 using many mechanisms including motor screw mechanism, linear actuators, and other mechanisms known in the art. Linear actuator is an actuator that creates linear motion. Many linear actuators are driven by a non-linear motion. Mechanical linear actuators typically operated by conversion of rotary motion into linear motion. The selection is made based on the cost of built and other factors.

The motor screw mechanism 80 is built in the preferred embodiment as shown in FIG. 2 where the motor screw mechanism 80 consists of a motor 81 and a long screw 82 attached to the motor 81. The set of motor 81 and screw 82 is installed under the right side 13 or left side 14 extending between the front end 11 and the rear end 12 of the seat 10 and is used to convert the rotational motion of the motor-screw into linear motion. A pillow block 83 is mounted on this motor-screw set 80 as housing. The sliding-part seat 16 can be moved forward or backward on the rails 17 depending on the direction of rotation of the motor 81. The rails 17 and the motor-screw mechanism 80 are assembled such that there is no obstruction to the user's legs when the sliding-part seat 16 moves onto the toilet seat 2.

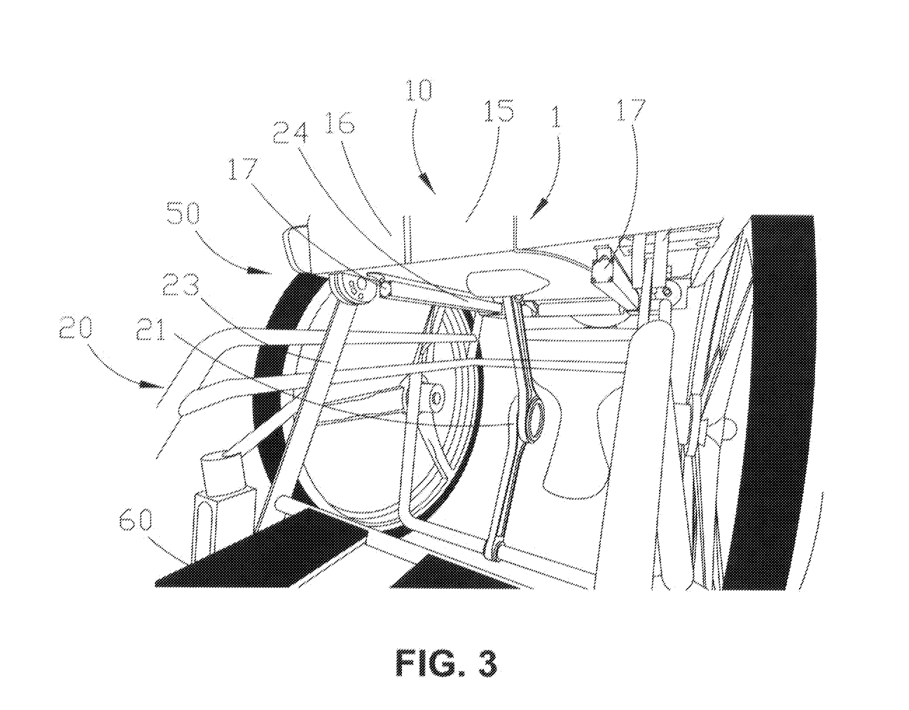

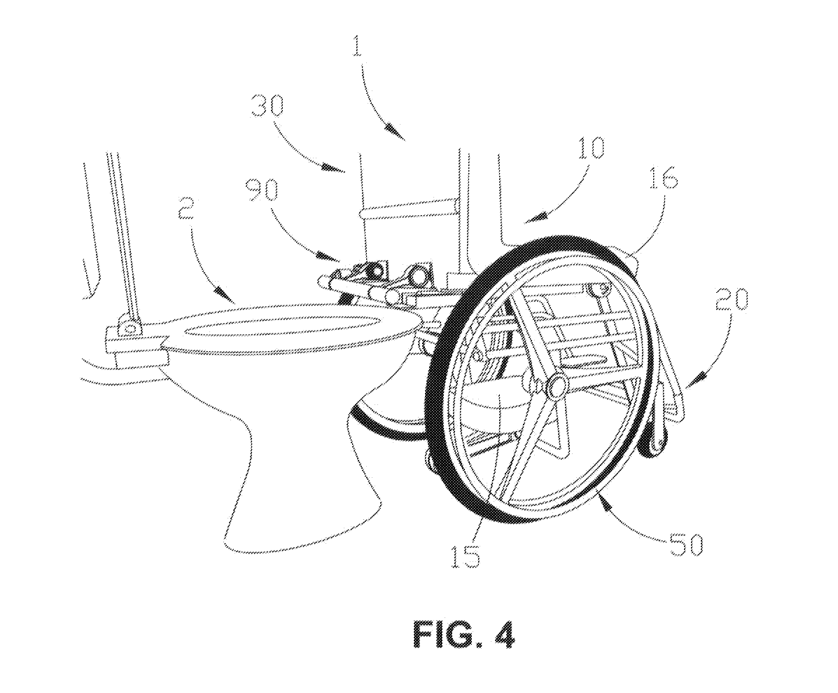

Referring to FIG. 3, there is disclosed a zoom-in view of the chair base member 20 according to the preferred embodiment of the present invention. The chair base member 20 is made up of metallic frame and is installed below the split seat 10. The chair base member 20 includes a joint mechanism 21 that is connected with the retractable-part seat 15 and can withdraw said retractable-part seat 15 to the space in between the two wheels 50, not obstructing the legs of the user as shown in FIG. 4. In this configuration, the split seat 10 not only offers a user supporting position by sliding-part seat 16, it offers an opening for the user to use the toilet without being transferred from the wheel chair 1 to toilet seat 2 once the wheel chair 1 is moved over the toilet seat 2. A pair of peddles 60 are connected to the lower end of a pair of metallic sticks 23 for user to place feet.

As illustrated in FIG. 4, a heavy duty metallic U-shaped roller 90 is pivotally affixed at its two ends to the back of the back member 30 near the rear end 12 of the split seat 10. When not in use, the roller 90 may be folded up towards the back of the back member 30. As the retractable-part seat 15 starts to move down and the sliding-part seat 16 starts to move backward, the roller 90 will unfold and move down toward the toilet seat to provide additional support.

The reconfigurable wheel chair 1 of the present invention may further include sensors 70 (not shown in Figures). Once the user enters the restroom, sensors 70 could be used to align the chair 1 to the toilet seat 2 automatically. The sensors 70 are mounted onto the wheel chair 1. Two of the many possible mechanisms are described below:
Tracking With Beacon—This mechanism includes a sensor 70 mounted at the back of the chair (S1) and another at the front of the toilet (S2). The S1 emits infrared (IR) radiation that detects the location of the S2. Once detected, the wheel chair 1 is automatically routed to align with the toilet 2.
Tracking With Line—This involves drawing a line on the floor from the restroom door to the toilet 2. Sensors 70 are mounted at the bottom of the seat 10 of the chair 1 to detect the line. This sensor 70, once enabled, can track the line to the toilet seat 2 automatically.

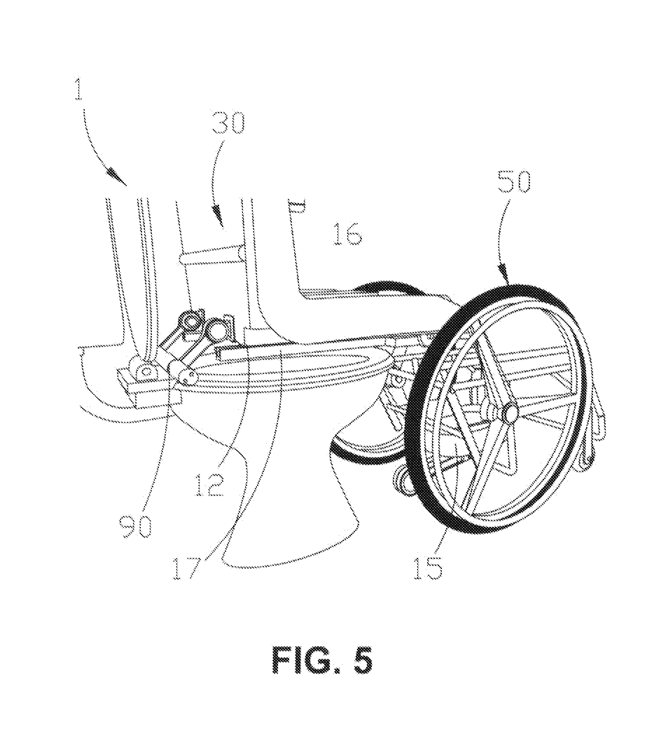

Once the wheel chair 1 is aligned with the toilet seat, the retractable-part seat 15 starts to move down; the motor screw mechanism 80 being activated starts to drive the sliding-part seat 16 to move backward on the rails 17 into position over the toilet seat 2; the roller 90 being moved downward onto the toilet seat locks and secures the wheel chair and provides additional support to the wheel chair and weight of the user. The final position is shown in FIG. 5.

This chair can be used in any toilets including home or outside. The dimensions are adjusted according to the ANSI A117.7 standard set by the Americans with Disabilities Act (ADA).

The reconfigurable wheel chair 1 according to the present invention may further comprise microchips that can control the joint mechanism 21 to withdraw the retractable-part seat 15, the motor screw mechanism 80 to move the sliding-part seat 16 forward or backward, the roller 90 to unfold and move down onto the toilet seat 2, and the sensors 70 for tracking and alignment between the wheel chair 1 and the toilet seat 2. The wheel chair 1 of the present invention may be controlled by wire or wireless remote control. The aforementioned mechanisms may be manually operable, for example, the joint mechanism 21 may be controlled by handles or levers; the motor screw mechanism of linear actuator may be controlled by a rotating knob or button.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A reconfigurable wheel chair comprising:
(a) a split seat having a front end, a rear end, a right side, a left side, a top, and a bottom, including a retractable-part seat and a sliding-part seat, said retractable-part seat is located at the center of said split seat and said sliding-part seat is the remaining portion of said split seat;
(b) a back support member connecting with said rear end of said split seat;
(c) a pair of heavy duty seat rails affixed to said split seat for supporting said sliding-part seat;
(d) means for driving said sliding-part seat to move forward and backward;
(e) means for withdrawing said retractable-part seat to move downward;
(f) means for providing additional support as said sliding-part seat moving backward; and
(g) means for aligning said wheel chair to the toilet.

2. The reconfigurable wheel chair of claim 1, wherein said retractable-part seat is oval in shape.

3. The reconfigurable wheel chair of claim 1, wherein said pair of seat rails are affixed to said bottom of said right side and left side of said split seat and extend between said front end and rear end for supporting said sliding-part seat.

4. The reconfigurable wheel chair of claim 1, wherein means for driving said sliding-part seat to move forward and backward include a motor screw mechanism, which includes a motor and a long screw that is attached to said motor; said motor screw mechanism is installed under said right side or left side extending between said front and rear ends of said seat and is used to convert the rotational motion into linear motion; said motor screw mechanism is housed in a pillow box, which is affixed to said bottom of said sliding-part of said split seat.

5. The reconfigurable wheel chair of claim 1, wherein means for driving said sliding-part seat to move forward and backward include a linear actuator; said linear actuator is installed under said right side or left side and extend between said front and rear ends of said seat and is used to convert the rotational motion into linear motion; said linear actuator is housed in a pillow box, which is affixed to said bottom of said sliding-part of said split seat.

6. The reconfigurable wheel chair of claim 1, wherein means for aligning said wheel chair to a toilet include tracking with beacon, which includes a sensor (S1) mounted at the back of the chair and another at the front of the toilet (S2); said S1 sensor emits infrared radiation that detects the location of said S2 sensor; once detected, said wheel chair is automatically routed to align with said toilet.

7. The reconfigurable wheel chair of claim 1, wherein means for aligning said wheel chair to a toilet include tracking with line, which include a sensor being mounted at the base of said wheel chair to detect a line drawn on the floor from the rest room door to the toilet; said sensor once enabled can track said line to said toilet automatically.

8. The reconfigurable wheel chair of claim 1, wherein means for providing additional support as said sliding-part seat moving backward include a U-shaped roller pivotally affixed at its two ends to the back of said back support member; said roller moves toward toilet seat and locks into position thus providing additional support for said sliding-part seat and the weight of the user.

9. The reconfigurable wheel chair of claim 1 further comprises a pair of hand supports attached to said back support member; a base member made up of metallic frame for supporting said split seat and said back support member; at least a pair of chair wheels connecting with said base member; and a pair of foot pedals connecting with said base member.

10. The reconfigurable wheel chair of claim 1, wherein said means for withdrawing said retractable-part seat to move downward include a joint mechanism; said joint mechanism withdraws said retractable-part downward to a space in between chair wheels.

11. The reconfigurable wheel chair of claim 1 may be manually operated including handles or levers for said means for withdrawing said retractable-part seat and means for providing additional support as said sliding-part seat moving backward, and a rotating knob or button to control means for driving sliding-part seat.

12. The reconfigurable wheel chair of claim 1 may further comprise microchips to control operation of wheel chair through wire or wireless remote control.

13. The reconfigurable wheel chair of claim 1 wherein said split seat being rigid and can be upholstered and cushioned for comfort.

14. A reconfigurable wheel chair comprising:
(a) a split seat having a front end, a rear end, a right side, a left side, a top, and a bottom, including a retractable-part seat and a sliding-part seat, said retractable-part seat is located at the center of said split seat and said sliding-part seat is the remaining portion of said split seat;
(b) a back support member connecting with said rear end of said split seat;
(c) a base member made up of metallic frame for supporting said split seat and said back support member, including a joint mechanism that can withdraw said retractable-part seat downward;
(d) at least a pair of chair wheels connecting with said base member;
(e) a pair of foot pedals connecting with said base member;
(f) a pair of heavy duty seat rails affixed to said bottom of said right side and left side of said split seat and extend between said front end and rear end for supporting said sliding-part seat;
(g) means for driving said sliding-part seat forward and backward;
(h) a roller at the back of back support member to provide additional support as said sliding-part seat moving backward; and
(i) means for aligning said wheel chair to the toilet.

15. The reconfigurable wheel chair of claim 14, wherein means for driving said sliding-part seat to move forward and backward include a linear actuator; said linear actuator is installed under said right side or left side and extend between said front and rear ends of said seat and is used to convert the rotational motion into linear motion; said linear actuator is housed in a pillow box, which is affixed to said bottom of said sliding-part of said split seat; said linear actuator include a motor and a screw that is attached to said motor.

16. The reconfigurable wheel chair of claim 14, wherein means for aligning said wheel chair to a toilet include tracking with beacon, which includes a sensor (S1) mounted at the back of the chair and another at the front of the toilet (S2); said S1 sensor emits infrared radiation that detects the location of said S2 sensor; once detected, said wheel chair is automatically routed to align with said toilet.

17. The reconfigurable wheel chair of claim 14, wherein means for aligning said wheel chair to a toilet include tracking with line, which include a sensor being mounted at the base of said wheel chair to detect a line drawn on the floor from the rest room door to the toilet; said sensor once enabled can track said line to said toilet automatically.

18. The reconfigurable wheel chair of claim 14 may further comprise microchips to control operation of wheel chair through wire or wireless remote control.

19. The reconfigurable wheel chair of claim 14 may be manually operated including handles or levers for said joint mechanism and said roller, and a rotating knob or button to control means for driving sliding-part seat.
